(19) United States
(12) Patent Application Publication
(10) Pub. No.: US 2011/0135289 A1
(43) Pub. Date: Jun. 9, 2011

(54) WATER HEATING SYSTEM WITH POINT-OF-USE CONTROL

(76) Inventor: Kenneth W. Kayser, Catawba, VA (US)

(21) Appl. No.: 12/963,025

(22) Filed: Dec. 8, 2010

Related U.S. Application Data
(60) Provisional application No. 61/267,699, filed on Dec. 8, 2009.

(51) Int. Cl. F24H 1/18; H05B 1/02

(52) U.S. Cl. 392/449; 219/494

(57) ABSTRACT

A water heater system includes an intermediate water heater having a storage tank in which water is initially received at an initial temperature. The intermediate water heater is controllable to heat the water to an intermediate temperature that is higher than the initial temperature. The water heater system also includes at least one point-of-use water heater coupled to the intermediate water heater for receiving the water from the intermediate water heater after the water has been heated to the intermediate temperature. The point-of-use heater is controllable to heat the received water to a point-of-use temperature, the point-of-use temperature being higher than the intermediate temperature.

### REFERENCE TO RELATED APPLICATIONS

This application is related to and claims priority to U.S. Provisional Patent Application Ser. No. 61/267,699, filed Dec. 8, 2009, which is incorporated herein in its entirety.

### FIELD OF THE INVENTION

The present invention relates generally to a hot water system, and more particularly, to a combination of an intermediate water heater and a point-of-use water heater.

### BACKGROUND OF THE INVENTION

Storage water heaters (also commonly referred to as water tanks) are generally used in household and commercial applications for providing hot water ready for use. Typical storage water heaters include a cylindrical container that has a typical volume range from about 20 to 100 gallons. The storage water heater is installed, typically, in a central location from where water pipes direct the water to a specific point-of-use. Both the storage water heater and the water pipes require insulation to reduce heat loss. In general, the more insulation the more energy efficient the storage water heater.

An alternative type of water heater is a point-of-use water heater (also referred to as tankless water heaters). Some point-of-use water heaters are generally popular in European countries and have a relatively smaller volume range, from about 2 to 6 gallons. The point-of-use water heaters instantly heat water as it flows through the device. The point-of-use water heaters do not retain any water internally except for what is in a heat exchanger coil of the point-of-use water heater. Typically, point-of-use water heaters are installed in a house or building far from a central water heater at a particular point-of-use (e.g., faucet, shower, etc.).

Supporters of using point-of-use water heaters note that these types of water heaters conserve water consumption because, by providing instant hot water, it is not necessary to run water until the water becomes hot (which is typical when using a storage water heater). However, current water heater systems, including point-of-use water heaters, are plagued by problems.

One problem associated with current water heater systems is that they consume too much electrical energy and, consequently, are expensive to operate and emit too much carbon dioxide (CO2). For example, the United States Environmental Protection Agency (EPA) will not approve systems having a plurality of point-of-use water heaters because they will likely draw too much peak electrical current. Another problem associated with some current water heater systems is that they often lack proper insulation and, as such, waste energy by continuously having to reheat stored water.

What is needed, therefore, is a water heater system that addresses the above-stated and other problems.

### SUMMARY OF THE INVENTION

According to one aspect, a water heater system includes an intermediate water heater having a storage tank in which water is initially received at an initial temperature. The intermediate water heater is controllable to heat the water to an intermediate temperature that is higher than the initial temperature. The water heater system also includes at least one point-of-use water heater coupled to the intermediate water heater for receiving the water from the intermediate water heater after the water has been heated to the intermediate temperature. The point-of-use heater is controllable to heat the received water to a point-of-use temperature, the point-of-use temperature being higher than the intermediate temperature.

According to another aspect, a method for heating water in a water heater system includes receiving water at an initial cold temperature in a storage tank of a central water heater. The water is heated in the storage tank to a warm temperature. From the storage tank, the water is received at one or more point-of-use water heaters. In response to detecting a water request at a point-of-use device, the water is heated at the point-of-use water heater to a hot temperature.

According to yet another aspect, a water heater system includes a central water heater having an uninsulated storage tank in which water is initially received at a first temperature, the central water heater receiving electrical power to increase temperature of the water to a second temperature. A plurality of point-of-use water heaters are coupled to the central water heater via respective uninsulated water pipes for receiving the water from the central water heater. The plurality of point-of-use water heaters are adapted to increase the temperature of the water from the second temperature to a third temperature. A priority controller is communicatively coupled to the central water heater and to the plurality of point-of-use water heaters, the priority controller being programmable to automatically send electrical power, as required, to the central water heater and point-of-use water heaters.

### BRIEF DESCRIPTION OF THE DRAWINGS

The invention may best be understood by reference to the following description taken in conjunction with the accompanying drawings, in which:

FIG. 1 is an illustration of a water heater system having an intermediate water heater tank and a plurality of point-of-use water heaters.

FIG. 2 is an illustration of a point-of-use water heater having a predictive control feature.

FIG. 3 is a flowchart for predictive control of a point-of-use heater.

### DETAILED DESCRIPTION OF THE ILLUSTRATED EMBODIMENTS

Although the invention will be described in connection with certain preferred embodiments, it will be understood that the invention is not limited to those particular embodiments. On the contrary, the invention is intended to cover all alternatives, modifications, and equivalent arrangements as may be included within the spirit and scope of the invention as defined by the appended claims.

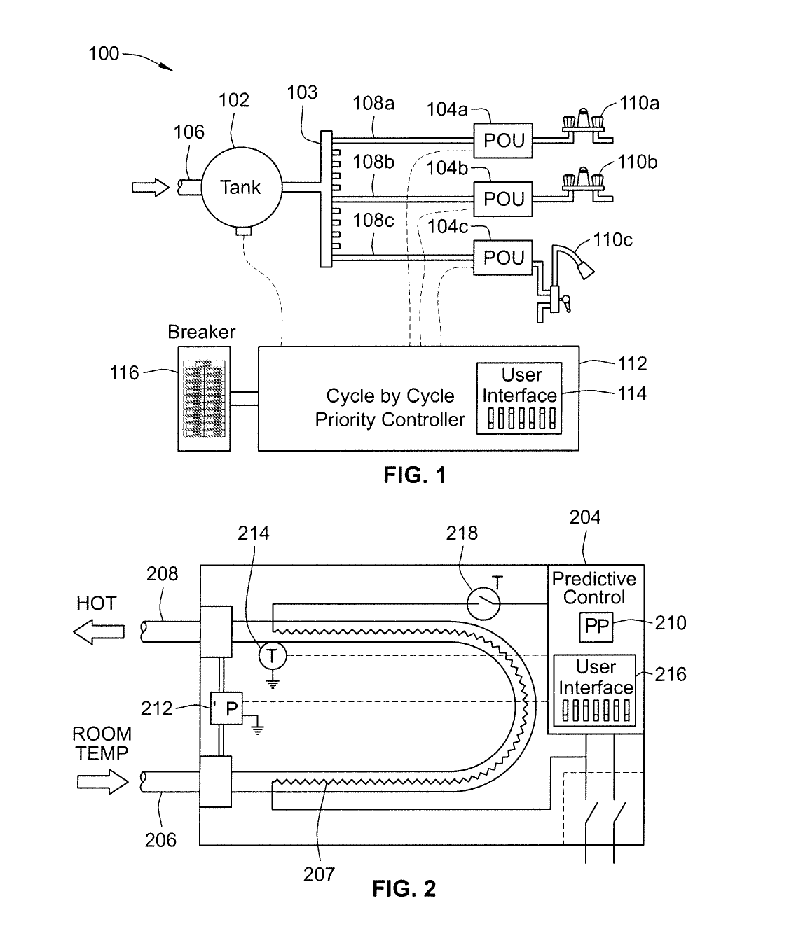

Referring to FIG. 1, a water heater system 100 includes a central water heater 102 and a plurality of point-of-use water heaters 104a-104c. Water at an initial, cold, temperature, (e.g., 60° Fahrenheit) is received in a storage tank of the central water heater 102 via a water inlet 106. The central water heater 102 heats the water from the cold temperature to an intermediate temperature, e.g., 75° Fahrenheit, which is also referred to as “room temperature.” The central water heater 102 can be powered by one or more types of power, such as electrical power, gas power, or solar power.

After the water is heated to the intermediate temperature, the water is transported through a water manifold 103 to the point-of-use water heaters 104a-104c via respective ones of water pipes 108a-108c. Accordingly, upon arrival at the point-of-use water heaters 104a-104c, the water temperature has already been increased from the cold temperature to room temperature. The point-of-use water heaters 104a-104c further heat the water to a final, hot, temperature, e.g., 115° Fahrenheit.

In response to a user request, the hot water is available for use at a point-of-use device, such as a water shower and a faucet. For example, a first point-of-use water heater 104a is installed for use with a first faucet 110a, a second point-of-use water heater 104b is installed for use with a second faucet 110b, and a third point-of-use water heater 104c is installed for use with a water shower 110c.

In addition to other advantages, such as savings associated with electrical current consumption, an advantage of the present water heater system 100 is that insulation is not required for either the storage tank of the central water heater 102 or for the water pipes 108a-108c (e.g., the water pipes 108a-108c can be uninsulated pipes). The reason for this advantage is based on the relatively nonexistent heat difference between the water temperature and the environment. In other words, the intermediate water temperature—of about 75° Fahrenheit—is approximately the same as the surrounding “room” environment. As such, negligible heat loss (if any) may occur from the intermediate, warm, temperature to the surrounding environment. In contrast, prior systems that heat the water directly to the final, hot, temperature—of about 115° Fahrenheit or higher—must contend with high heat loss based on the great difference between the two temperatures, e.g., a temperature difference of at least 40° Fahrenheit.

The central water heater 102 and the point-of-use water heaters 104a-104c are communicatively coupled to a priority controller 112. A user can set a preferred priority via a user interface 114 to determine how much electrical power is received by each of the central water heater 102 and the point-of-use water heaters 104a-104c when at least two water heaters 102, 104a-104c require electrical power simultaneously (e.g., when the first faucet 110a and the water shower 110c are used simultaneously). The priority controller 112 is communicatively coupled to a circuit breaker 116.

If only one of the water heaters 102, 104a-104c requires electrical power at one time, a priority determination is not required. However, when multiple water heaters 102, 104a-104c require electrical power simultaneously, the priority controller 112 controls electrical power output to the water heaters 102, 104a-104c, for example, every half cycle. A cycle is, generally, a predetermined time period that is a function of electrical current frequency, i.e., 1/frequency. For example, electrical current having a 60 Hertz frequency will have a cycle of 1/60 Hertz, resulting in a frequency of about 16.7 milliseconds. Thus, a determination made every half cycle will occur approximately every 8 milliseconds. According to an exemplary embodiment, the controller 112 determines every half cycle if electrical power should be sent to any of the water heaters 102, 104a-104c for the following half cycle.

The user may assign, for example, the lowest priority (e.g., priority 4) to the central water heater 102 and the highest priority (e.g., priority 1) to the third point-of-use water heater 104c (which is associated with the water shower 110c). If both the central water heater 102 and the third point-of-use water heater 104c require electrical power simultaneously, the priority controller 112 may send some electrical power to each water heater, but the higher-priority heater 102, 104c will receive more electrical power. For example, the priority controller 112 may determine during a first half cycle that the third point-of-use water heater 104c is more important and, as such, it will receive twice as much electrical power as the central water heater 102. Consequently, the priority controller 112 may send electrical power to the third point-of-use water heater 104c for a full cycle of about 16 milliseconds, after which the priority controller 112 may send electrical power to the central water heater 102 for the next half cycle of about 8 milliseconds.

According to the above example, the priority controller 112 can continue alternating electrical power output between the third point-of-use water heater 104c and the central water heater 102 until only a single water heater requires electrical power (e.g., the water shower 110c is turned OFF and, as such, the third point-of-use water heater 104c no longer requires electrical power), or until another condition requires a change in priority (e.g., a higher priority devices is turned ON).

Optionally, the priority controller 112 can be programmed such that a maximum electrical current is never exceeded. For example, the priority controller 112 can provide electrical power to the water heaters 102, 104a-104c such that the total drawn electrical current does not exceed 60 Amperes of electrical power.

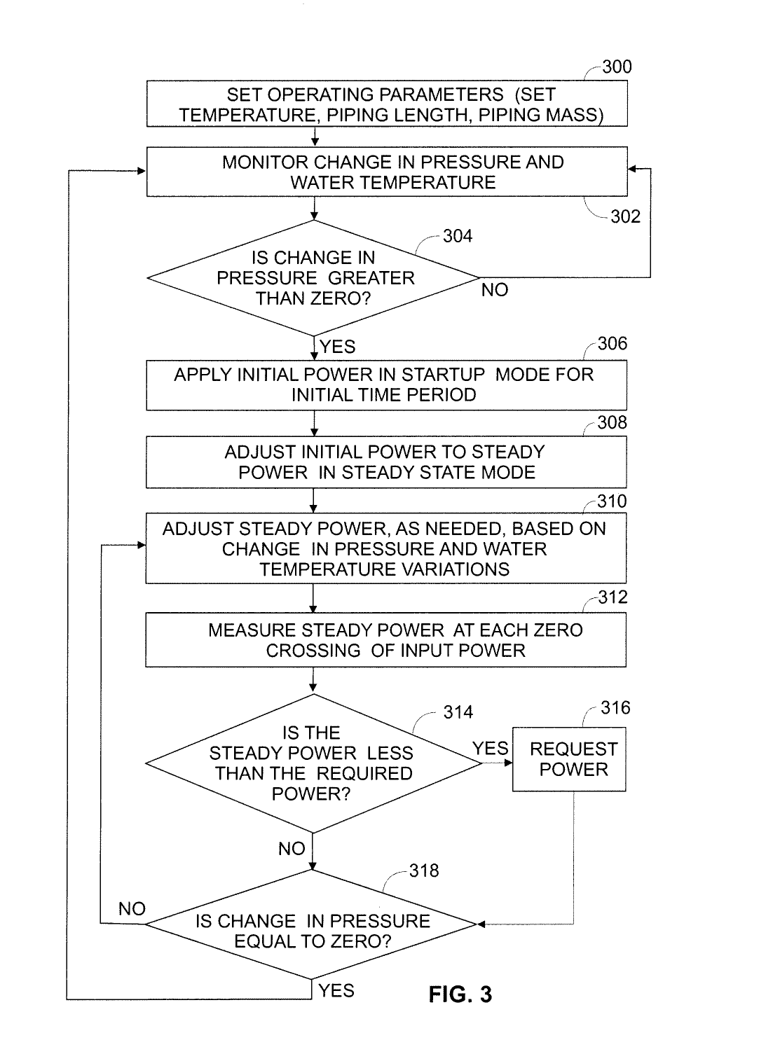

Referring to FIG. 2, a point-of-use water heater 204 includes a warm water inlet 206 for receiving warm water from a central water heater, one or more heating elements 207 for heating the warm water, and a hot water outlet 208 for sending hot water to a point-of-use device. The heating elements 207 receive electrical power in accordance with a predictive control feature that determines electrical power input based on a predictive control algorithm. The predictive control algorithm may be stored and executed via a microprocessor (μP) 210.

Measurements indicated by a pressure sensor 212 show a pressure drop ΔP, based on which the water flow rate can be calculated. Specifically, when the change in pressure exceeds a predetermined limit, a signal is sent to the microprocessor 210 to indicate that water is flowing at a particular flow rate. Then, the microprocessor 210 determines how much electrical power is required based on the particular flow rate and an initial temperature, which is provided by a temperature sensor 214. The microprocessor 210 may require a larger electrical power load for an initial time period because the water pipes are colder, and, as such, more energy is required to heat up the water pipes. The initial time period may last for a few seconds and is determined by user input via a user interface 216.

To determine the initial time period and the associated initial electrical power load, dip switches of the user interface 216 are set by the user in accordance with various system properties, which may include water pipe length, water pipe material (e.g., copper), etc. The initial time period, for example, may be increased based on how far a faucet is installed from the point-of-use water heater 204. The longer the distance (i.e., the water pipe), the longer the initial time period. After the initial time period, the initial electrical power is reduced to a steady electrical power.

The microprocessor 210 continually monitors water temperature. If the water temperature increases over a predetermined value, the electrical power to the point-of-use water heater 204 is further reduced. As a precaution, a temperature safety shutoff switch 218 can send a signal to completely remove electrical power from the point-of-use water heater 204 if the water temperature increases above an undesirable temperature.

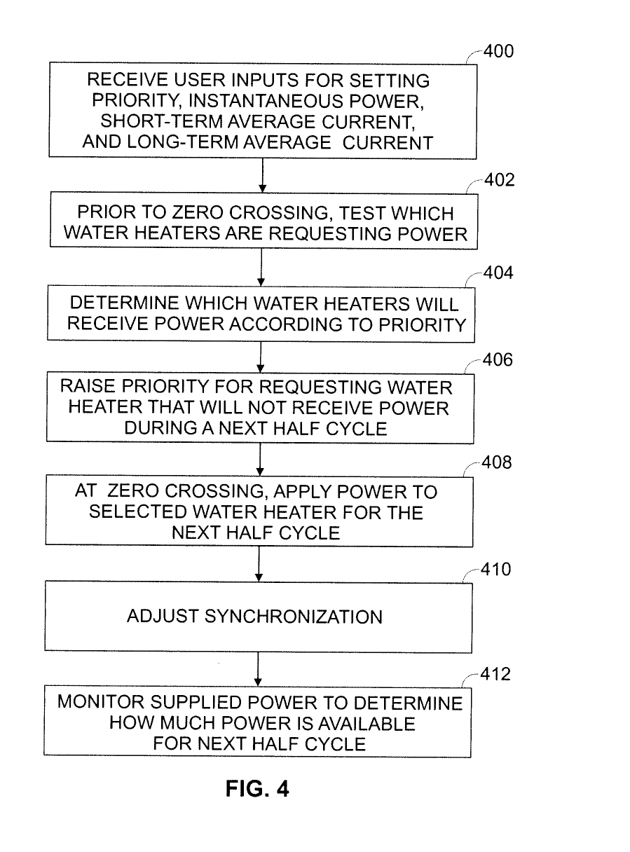

Referring to FIG. 3, a predictive control method for heating water in the water heater system 100 includes setting of operating parameters (300), which include a set temperature Tset, a piping length Lo, and a piping mass Mo. The piping mass Mo is determined based, for example, on the piping material, such as copper or plastic. The water temperature Tw and changes in water pressure ΔP are monitored (302), waiting for the change in pressure ΔP to be greater than zero. The change in pressure ΔP indicates a specific water flowrate. For example, the greater the change in pressure ΔP, the greater the water flowrate.

Upon determining that the change in pressure ΔP is greater than zero (304), an initial power Pi is applied in a startup mode for an initial time period (306). The startup mode is directed to preheating the water pipes between a point-of-use heater and an associated device, e.g., a faucet. For example, assuming that the point-of-use heater is a 6 kilowatt heater, the initial power Pi may be 6 kilowatts and the initial time period may be 2 seconds.

After the initial time period, the initial power Pi is adjusted to a steady power P in a steady state mode (308). For example, the steady power P may be only 2 kilowatts, which may be achieved by turning the point-of-use heater ON every third half cycle. As needed, based on change in pressure ΔP and water temperature Tw variations, the steady power is adjusted (310). The steady power P may also be affected by priority considerations, as discussed in more detail below in reference to FIG. 4.

At each zero crossing of input power (i.e., where the waveform crosses at zero for an alternating current, such as 120 AC) the steady power is measured (312) to determine if additional power is required. If the steady power is less than the required power (314), additional power is requested (316). If the change in pressure ΔP is back to zero (318), power is shutoff and the system goes back to monitoring change in pressure and water temperature (302).

Referring to FIG. 4, a priority control method for heating water in the water heater system 100 includes receiving user inputs related to setting priority (400), including instantaneous power, short-term average current, and long-term average current. The user also provides inputs to prioritize each water heater.

Prior to each zero crossing, each water heater is tested to determine which ones are requesting power (402). Then, if the available power is less than the requesting power, a further determination is made to determine which water heaters will receive power based on the preset priority (404). If a water heater does not receive power for a particular half cycle, the priority for that water heater is raised (406) to increase likelihood that the water heater will receive power during a next half cycle.

At a zero crossing, power is applied to selected water heaters for the next half cycle (408). Also, synchronization is adjusted (408) to ensure synchronicity between the priority controller 112, which has its own internal oscillator, and the received power. The supplied power is monitored to determine how much power is available for the next half cycle (410).

While particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

1. A water heater system comprising:
an intermediate water heater including a storage tank in which water is initially received at an initial temperature, the intermediate water heater being controllable to heat the water to an intermediate temperature that is higher than the initial temperature; and
at least one point-of-use water heater coupled to the intermediate water heater for receiving the water from the intermediate water heater after the water has been heated to the intermediate temperature, the point-of-use heater being controllable to heat the received water to a point-of-use temperature, the point-of-use temperature being higher than the intermediate temperature.

2. The water heater system of claim 1, wherein the intermediate temperature is a room temperature of approximately 75° Fahrenheit and the point-of-use temperature is a hot temperature of at least about 115 degrees Fahrenheit.

3. The water heater system of claim 1, further comprising an uninsulated water pipe connected between the intermediate water heater and the at least one point-of-use water heater.

4. The water heater system of claim 1, wherein each of the intermediate water heater and the point-of-use water heater include a 6 kilowatt heater.

5. The water heater system of claim 1, wherein the point-of-use water heater is installed near a point-of-use device selected from at least one of a faucet and a shower head.

6. The water heater system of claim 1, wherein the point-of-use water heater includes a pressure sensor for detecting when the point-of-use device is turned ON.

7. The water heater system of claim 1, further comprising a programmable controller communicatively coupled to the intermediate water heater and the at least one point-of-use water heater, the programmable controller being operative to control the supply of electrical power to the intermediate water heater and the at least one point-of-use water heater.

8. The water heater system of claim 7, wherein the programmable controller is operative to determine electrical power priority when two or more of the intermediate water heater and the at least one point-of-use water heater are ON simultaneously.

9. The water heater system of claim 8, wherein the at least one point-of-use water heater is deemed to be a higher-priority heater than the intermediate water heater.

10. The water heater system of claim 8, wherein the programmable controller determines electrical power priority after each one of one or more predetermined time intervals until at least one of the two more of the intermediate water heater and the at least one point-of-use water heater is OFF.

11. A method for heating water in a water heater system, the method comprising:
receiving water at an initial cold temperature in a storage tank of a central water heater;
heating the water in the storage tank to a warm temperature;
receiving the water from the storage tank at a point-of-use water heater; and
in response to detecting a water request at a point-of-use device, heating the water at the point-of-use water heater to a hot temperature.

12. The method of claim 11, further comprising receiving the water from the storage tank at another point-of-use water heater.

13. The method of claim 11, further comprising, in response to a priority controller detecting a water request, automatically receiving electrical power to one or more of the central water heater and the point-of-use water heater.

14. The method of claim 11, further comprising prioritizing supply of electrical power to the central water heater and to the one or more point-of-use water heaters via a controller programmed to include a predictive algorithm, the predictive algorithm being a function of change in pressure, temperature, and time.

15. The method of claim 14, wherein each of the central water heater and the one or more point-of-use water heaters are ranked from a higher priority heater to a lower priority heater, the higher priority heater receiving more electrical power than the lower priority heater.

16. The method of claim 15, wherein the point-of-use water heater initially receives a first electrical power during an initial time period, the point-of-use water heater receiving a second electrical power during a subsequent time period, the first electrical power being greater than the second electrical power, the first electrical power being determined based on water pipe properties including at least one of water pipe length and water pipe mass.

17. The method of claim 14, wherein the priority controller is operative to determine a current electrical power priority repeatedly after each of one or more predetermined time intervals.

18. A water heater system comprising:
a central water heater having an uninsulated storage tank in which water is initially received at a first temperature, the central water heater receiving electrical power to increase temperature of the water to a second temperature;
a plurality of point-of-use water heaters coupled to the central water heater via respective uninsulated water pipes for receiving the water from the central water heater, the plurality of point-of-use water heaters being adapted to increase the temperature of the water from the second temperature to a third temperature; and
a priority controller communicatively coupled to the central water heater and to the plurality of point-of-use water heaters, the priority controller being programmable to automatically send electrical power, as required, to the central water heater and point-of-use water heaters.

19. The method of claim 18, wherein the priority controller is further programmable to include a predictive algorithm for determining priority when two or more of the central water heater and the plurality of point-of-use water heaters require electrical power.

20. The method of claim 19, wherein, for any one of the point-of-use water heaters and the central water heater, the priority controller is further programmable to raise priority during a next time cycle if power was not received during an initial time cycle.
